(19) United States
(12) Patent Application Publication
(10) Pub. No.: US 2021/0126531 A1
(43) Pub. Date: Apr. 29, 2021

(54) Input Circuit for a Power Supply

(71) Applicant: Siemens Aktiengesellschaft, Muenchen (DE)

(72) Inventors: Thomas Rothmayer, Wien (AT); Harald Schwelgert, Wien (AT)

(21) Appl. No.: 17/253,277

(22) PCT Filed: Jun. 17, 2019
(86) PCT No.: PCT/EP2019/065826

§ 371 Date: Dec. 17, 2020

(30) Foreign Application Priority Data
Jun. 20, 2018 (EP) 18178782

(51) Int. Cl. H02M 3/156; H02H 7/12; H02M 1/32

(52) U.S. Cl. CPC H02M 3/156; H02M 1/32; H02H 7/1213

(57) ABSTRACT

An input circuit for a power supply includes an input voltage that is converted into an output voltage via periodic switching of a switch between conductive/blocked states, wherein current that charges a capacitance and supplies output voltage flows through an inductor at least during switching of the switch, and is absorbed by an active switch unit when the switch is in the blocked state and is permitted through the switch in the blocked state, upon exceeding a predefined breakdown voltage at the switch, such that during an overvoltage at the input circuit, the switch is switched into the blocked state, and current flow that then occurs is relayable into the inductor and the active switch unit is deactivatable, the switch and inductor being dimensioned such that, during an overvoltage, an “avalanche energy” occurs at the switch, upon which the switch withstands the current flowing through the inductor during the over-voltage.

### CROSS-REFERENCE TO RELATED APPLICATIONS

This is a U.S. national stage of application No. PCT/EP2019/065826 filed 17 Jun. 2019. Priority is claimed on European Application No. 18178782.1 filed 20 Jun. 2018, the content of which is incorporated herein by reference in its entirety.

### BACKGROUND OF THE INVENTION

### 1. Field of the Invention

The subject matter of the invention generally relates to the field of electrical engineering and, more particularly, to the area of power electronics as well as to power electronics circuits and, more specifically, relates to an input circuit for a power supply, where an input voltage of the input circuit is converted into an output voltage of the input circuit by periodically switching a switch element between a conductive and a blocked state, where an inductance arranged in series with the switching element has a current flowing through it at least partially during a switching period, where this current charges an output-side capacitance, by which the output voltage is supplied, and is absorbed by an active switch unit when the switch element is in the blocked state, and where a current flow is permitted through the switch element in the blocked state when a predefined breakdown voltage is exceeded at the switch element.

### 2. Description of the Related Art

In automation technology, power supplies are frequently employed nowadays by which a DC voltage is supplied as an output voltage for supplying consumers, such as control electronics or other parts of electrical plant. Power supplies of this type deliver a prespecified output voltage as the predefined supply voltage (e.g., 24V DC voltage as rated output voltage and 28V DC voltage as maximum output voltage). A power supply of this type is usually fed from a single or multi-phase, mostly a three-phase, power supply system, where for example it is increasingly necessary, through the ever more frequent omission of a neutral conductor bar in electrical installations, to use power supplies that can generate a 24V DC voltage from a three-phase AC voltage of 400 to 500V, for example. Power supplies of this type are not infrequently constructed as multi-stage supplies for efficiency reasons. In such supplies, a rectifier unit is frequently provided as an input stage or input circuit, by which the AC voltage from the power supply system is converted into a usually unstabilized or unregulated DC voltage as an input voltage for the power supply. Furthermore, an intermediate stage or an intermediate circuit can be provided as input circuit for the power supply, by which the unstabilized or unregulated intermediate voltage is converted, so that, for example, an efficient converter stage arranged thereafter obtains a defined input voltage. From the regulated intermediate circuit voltage, the predefined output voltage for the supply of consumers is then generated by this converter stage.

An increase in power electronics and a rising complexity of electrical installations, above all in the area of automation technology, has enabled system perturbations of the various devices or consumers linked to the supply system (e.g., motors, or power supplies) to further increasingly occur. These can, for example, lead to overlays of the interference impressed on the supply system and thus again to a higher load on the connected consumers. In particular, consumers with a comparatively low power, such as power supplies, are mostly barely capable of limiting or discharging interference that occurs, such as overvoltages. In particular, with switching actions on the supply system (e.g., tripping of a fuse, or adding or removing a large load), in particular through an inductive effect of longer supply lines, by which an attempt is made to maintain the current, overvoltage pulses are generated, which even consumers with comparatively low power, such as power supplies, must be able to withstand, and which are mostly significantly greater than the peak sine wave voltage of the predefined supply voltage or system voltage (e.g., 400 to 500V).

With power supplies that are linked to a three-phase supply system, it is nowadays usual, in the input stage, for example, to employ what are known as varistors to limit overvoltages. A varistor is an electronic component that is characterized by a voltage-dependent resistance. In a normal mode of operation (e.g., with a pre-specified system voltage), the resistance of a varistor is very large, so that it does not influence behavior of a circuit. Above a pre-specified threshold voltage, which is typical of the respective varistor, or for an overvoltage, the differential resistance of the varistor becomes relatively small almost without delay as the voltage present increases. This makes varistors suitable for protecting sensitive circuits, such as a power supply, against overvoltages. Employing varistors on the input side in a power supply enables very high currents to be discharged, for example, and enables overvoltages coming from the power supply network to be limited by building up a high pulse power loss.

The disadvantage of employing varistors, however, is a technology-related large tolerance of an actuation voltage and a high residual internal resistance that, when large currents are flowing, also causes a marked rise in the voltage that is needed to be able to discharge a current. This voltage is usually referred to as the protection level. This means that a power supply that is dimensioned for a supply with an AC voltage of 500V and by which, for example, safety standards such as UL508 (UL stands for Underwriters Laboratories Inc.®—one of the world's leading organizations for the testing and certification in the area of product safety) have to be adhered to, must be designed for peak voltage values in the event of overvoltages of up to around 2000V. By adhering to the safety standards (e.g., UL508), a varistor voltage of, for example, at least 20% above the predefined supply voltage (e.g., 500V AC voltage) is pre-specified (i.e., the rated varistor voltage must amount to at least 600V AC). Varistors available on the market that have such a rated varistor voltage (e.g., 625V AC), with high limiting currents (e.g., at 1000 Amperes or more), have a protection level in the region of a peak voltage of around 1800 to 2000V, for which the power supply must then be designed for the case of an overvoltage (especially so that the converter stage does not sustain any damage).

Patent DE 200 10 283 U1, for example, discloses a power supply with a low-loss starting current limiting, at which a current limiting element, such as a field effect transistor or insulated gate bipolar transistor (IGBT) is arranged in the DC voltage line after a rectifier. With the aid of a current sensor, a current is measured through the transistor switched to conductive and via a voltage sensor a voltage at the transistor. The signals of the two measuring facilities are logically linked and converted into an activation signal for the transistor. If for example a jump in voltage now occurs at the input of the power supply (e.g., switch-on process, voltage peak during operation) then this can lead to a relatively high current across the transistor, which is detected with the aid of the current sensor. The transistor is then put into a linear mode of operation and thereby limits current flowing into the circuit. This method can only be employed for relatively small input voltages (e.g., up to around 200V) and currents to be limited with low values, since the transistor (e.g., MOS-FET, IGBT) only has a restricted working capacity in linear mode.

With a supply of power by a three-phase system with, e.g., an AC voltage up to above 500V, the transistor, which is especially designed as an IGBT, is blocked, as from a differential voltage able to be predefined (e.g., 50V), for example, in order to protect it from too great a power loss in the linear mode. For charging of an intermediate circuit capacitance, a resistor can be arranged in parallel to the transistor, for example. This variation of power supply known from publication DE 200 10 283 U1 has the disadvantage however that, in the event of an overvoltage, for example, the supply is only switched off when relatively high currents occur across the transistor and that relatively high energy in the power supply when it is switched off can possibly generate internal overvoltages. Furthermore, the power supply has a relatively high harmonic component and thus a need for a choke with a laminated iron core, which in most cases is relatively large in size and leads to additional power loss of the power supply.

Devices, such as power supplies, have a non-linear characteristic load curve, even with a pure sine-wave supply voltage. As a result, distorted current and voltage curves can occur at the input or current harmonic oscillations or current harmonics. The system voltage is influenced by this and the harmonics can lead to interference in the respective supply system and thus at other devices connected to said system. Therefore, filters are usually employed, mostly after the input stage or the rectifier unit, in power supplies for limiting harmonics. Chokes with a high inductivity can be used, for example, as passive filters for limiting harmonics. These passive filters for limiting harmonics, although they are simple to manufacture, only achieve tolerably good results however. That is, the harmonics can only be limited with restricted effect via a choke. Furthermore, a choke with a relatively large size is mostly required because of the relatively low frequency.

Using an active filter for restricting harmonics, which makes sure that a current accepted largely corresponds to the sine-wave system voltage, represents a further possibility for restricting the harmonics. Switching converters can be employed as these types of filters, for example, which can be arranged, for example, after the input stage or in an intermediate stage of the power supply. The switching converter can be designed as a boost converter, for example, in which an amount of an output voltage is always greater than an amount of an input voltage. With relatively large input voltages, such, with a network voltage from 400 to 500V, this has the disadvantage that, for the stage of the power supply following the boost converter, the input voltage is further increased.

Boost converters are usually designed for use on a single-phase system, where a current accepted by them is fed directly to the system voltage and a very strong sine wave-like current shape is achieved. With a three-phase system voltage, a bridge circuit is usually used because of the different potentials of the individual phases relative to one another, in order to achieve a sine waveform current in all three phases. Bridge circuits of this type mostly consist of six individually activatable switch elements (e.g., MOS-FETs, or IGBTs) and one upstream inductance per phase in each case. Through a suitable activation of the six switch elements with a much higher switching frequency than a frequency of the supplying AC system voltage the desired current waveform can be achieved. These types of circuits are very component-intensive however and moreover need a complex activation circuit, which nowadays is mostly designed as a microprocessor circuit. Because of the high outlay involved, such circuits are predominantly employed in large converters, for example, because even small variations of the current from a sine waveform would have significant effects on system quality.

A further possibility that involves a lower outlay is provided by extracting the supply current for the power supply after a passive three-phase rectifier bridge. In this case, however, larger capacitances at the output of the rectifier bridge are to be avoided. The rectifier bridge provides a DC voltage with a ripple content, through which the current acceptance character of the connected circuit still has an appreciable influence on the overall harmonics. This means that, for example, the more of the accepted current of the pulsating output voltage follows the rectifier bridge, the smaller are the harmonics. Only the highest sections of the system phases are usually switched through in each case by the rectifier bridge, which with true sinewave load would also bring about the highest current flow. As a result, an input current following the voltage (despite the short current flow times per phase) would have a marked effect in reducing harmonics.

DE 10 2005 002 360 A1, for example, describes the use of a buck converter for reduction of harmonic oscillations of the system current input of clocked power supplies. However, the switching transistors usually used nowadays are not designed for high blocking voltages in the event of an overvoltage. Switching transistors with high blocking voltages (e.g., of 1500V), on the other hand, have very high starting resistances or are suitable only for rather low switching frequencies (e.g., up to 20 kHz), whereby the result can be very high switching losses and/or requirements for compact sizes of power supply are only able to be fulfilled with difficulty.

DE 10 2004 0569 455 A1 discloses a switching arrangement for overvoltage detection, in which a transient suppression with a switch (e.g. IGBT) is arranged downstream of a rectifier unit and a filter in order, by blocking the switch, to prevent an overvoltage reaching an output stage of the circuit arrangement. A command for switching off the switch is sent to the switch if a voltage limit value is exceeded, where a voltage is measured at the input and at the output of the filter. The output stage is embodied as a buck converter, for example, which comprises a MOS-FET as a switch for example and would also be used, for example, for reduction of harmonics. In addition, in parallel to the output of the transient filter unit, a series circuit consisting of a further switch and a varistor can be provided, where the switch is only activated or closed in the event of an overvoltage and the overvoltage is destroyed by the varistor. The switch arrangement known from patent DE 10 2004 0569 455 A1 has relatively high switch-on losses through the two switches (IGBT, MOS-FET), through which a level of effectiveness of the switch arrangement is reduced, which is why a further non-mass-related potential-free or so-called floating activation of the switches is necessary.

### SUMMARY OF THE INVENTION

In view of the foregoing, it is therefore an object of the invention to provide an input circuit for a power supply, which has a high efficiency and high dielectric strength in the event of overvoltages, and also improvements compared to the prior art.

This and other objects and advantages are achieved in accordance with the invention by an input circuit for a power supply, where the input circuit has at least one switch element arranged on the input side, an inductance arranged in series with this switch element and also an active switch unit. Through periodic switching of the switch element between a conductive and a blocked state, an input voltage of the input circuit is converted into an output voltage of the input circuit, where the output voltage is made available at a capacitance arranged on the output side. During a switching period of the switch element, the inductance has a current flowing through it at least partially, which charges the capacitance arranged on the output side. In the blocked state of the switch element, the current is absorbed by the active switch unit. Furthermore, in the blocked state of the switch element and, if a predefined breakthrough voltage is exceeded at the switch element, a flow of current via the switch element is permitted, where the predefined breakthrough voltage is higher or greater than a continuous operating voltage of the switch element. On recognition of an overvoltage on an input side of the input circuit, the switch element can be switched into the blocked state. The current flow via the switch element can be relayed to the inductance and switches the active switch element off. In this case, the switch element and the inductance are dimensioned such that, on occurrence of an overvoltage, “avalanche energy” arises at the switch element, for which the switch element withstands a current flowing through the inductance for the duration of the overvoltage.

The main aspect of the solution proposed in accordance with the invention consists of exploiting the fact that, in the blocked state, a flow of current via the switch element is made possible when in the blocked state of the switch element the voltage present at the switch element exceeds a predefined breakthrough voltage. The predefined breakthrough voltage in this case lies above the continuous operating voltage or rated voltage of the switch element. The predefined breakthrough voltage in this case is that voltage value as from which the flow of current via the switch element is permitted, where through this current flow a loss energy (e.g., in the form of heat) is created in the switch element. This loss energy can also be referred to as what is known as avalanche energy or breakthrough energy. In data sheets, the energy is usually designated by the abbreviation E_{AR} and provided with an explanation “single pulse energy”, for example, which is mostly specified at a peak temperature of 25° C. Typical values for a permitted avalanche energy usually lie in a range of 0.2 to 0.5 Joule.

The switch element and the inductance, into which the flow of current permitted via the switch element in the blocked state is relayed, are dimensioned in this case such that, on occurrence of an overvoltage or of an overvoltage pulse at the input of the input circuit, an avalanche energy arises for which the switch element withstands the current flowing through the inductance for the duration of the overvoltage. In normal switching mode of the switch element, the predefined breakthrough voltage does not occur, because otherwise the result would be significant and unwanted loses in the switch element or the switch element might possibly overheat.

The inventive input circuit in this case has the advantage of having an easy-to-realize circuit topology, and through the corresponding dimensioning of switch element and inductance, of having a high dielectric strength in the event of an overvoltage, whereby e.g. a use in supply systems with 400 to 500V AC voltage is made possible without problems in the event of an overvoltage. Furthermore, the inventive input circuit, as a result of the simplicity of the circuit or the components used, has a high efficiency or has a very good and high level of effectiveness, because for example no additional switches, such as IGBTs, which have forward power losses and activation losses, are employed for overvoltage protection. In addition, the input circuit is of a size that can be built into a switching cabinet easily and without additional space requirements.

It is furthermore advantageous if the switching element and the inductance are additionally dimensioned such that the predefined breakthrough voltage at the switch element and the output voltage produce at least one sum value at which the current flowing through the inductance remains below a maximum value able to be predefined on occurrence of a maximum overvoltage to be expected. Through this the dielectric strength of the input circuit is additionally increased in a simple manner. It is ensured, through the appropriate dimensioning of the switch element and the inductance, that a current with a predefined maximum value flows through the inductance, whereby the current flow via the switching element is also limited in the event of an overvoltage. That is, the switch element can withstand the current flowing through the inductance even more easily and better for the duration of the overvoltage.

In an expedient embodiment of the inventive input circuit, an activation unit for activation of the switch element is provided. The activation unit enables the switch element to be switched in normal operation from the conductive state into the blocked state or from the blocked state into the conductive state for example. To this end, the output voltage of the input circuit can be employed by the activation unit via a feedback, for example, to regulate the voltage to a predetermined value. The activation unit can furthermore be used, for example, to put the switch element into the blocked state on recognition of an overvoltage on the input side.

To recognize an overvoltage on the input side of the input circuit, a comparator unit is provided, which can be realized, for example, as an autonomous unit or can be integrated into the activation unit. An input side overvoltage is able to be recognized by the comparator unit, e.g., via voltage supervision. To this end, a voltage value able to be determined indirectly or directly on the input side of the input circuit can be supplied to the comparator unit, where this measured voltage value is compared with a predefined reference value. The value of the predefined breakthrough voltage or a somewhat lower value can be used, for example, as the predefined reference value for comparison with the measured voltage value determined. Then, when the reference value able to be predefined is exceeded, the switch element is put into the blocked state, e.g., via the activation unit, by the measured voltage value determined and supplied to the comparator unit. Thus, ideally a switch-off command is sent to the switch element before any high current can develop.

As an alternative, the comparator unit can also be configured such that an input-side overvoltage can be recognized based on a current building up as a consequence of or because of the overvoltage. To this end, the comparator unit can be supplied with a measured current value determined via a current sensor. The measured current value determined is then compared with a reference value able to be predefined and when the reference value able to be predefined is exceeded, the switch element is put into the blocked state, e.g., via the activation unit, by the measured voltage value determined and supplied to the comparator unit. For this purpose, the current sensor for determining the measured current value is arranged, for example, in a current path, which includes the flow of current through the switch element that is permitted at the switch element in the blocked state when the predefined breakthrough voltage is exceeded. When measured current values are used for switching the switch element into the blocked state, in an advantageous way in the event of an overvoltage there can be a very rapid reaction to the build-up of current, because a current flowing at the time (where this exceeds the reference value able to be predefined) is switched off with little or no delay.

It is advantageous for the switch element to be formed as a semiconductor switch, in particular as a metal oxide field effect transistor or MOS-FET, based on silicon carbide. Transistors based on silicon carbide (SiC) such as SiC-MOS-FETs, because they conduct heat well, are suitable, for example, for applications at which high temperatures must be withstood. That is, SiC-based semiconductor switches are suitable, for example, for withstanding higher blocking voltages. Ideally the silicon carbide-based semiconductor switch has a minimum acceptance capability predefined as a characteristic component value for the “avalanche energy”, such as an avalanche rating. This enables the input circuit and in particular the switching element to be formed very easily for the overvoltage events to be expected or for maximum overvoltage values to be expected.

As an alternative, the switch element can consist of a unit arranged in parallel to the semiconductor switch for limiting and accepting the avalanche energy in the event of an overvoltage. The semiconductor switch is relieved of the load of accommodating the avalanche energy by the unit for limiting and accommodating the avalanche energy arranged in parallel, because in the event of an overvoltage the semiconductor switch is put into the blocked state and the current flow into the inductance is primarily allowed via the unit for limiting and accommodating the avalanche energy arranged in parallel. The total converted avalanche energy in the switch element is defined in this case above all by the level and the duration of the overvoltage, by the dimensioning of the inductance and by a current that has flowed in the inductance beforehand. A switching transistor with avalanche rating, such as silicon-based MOS-FETs, or without avalanche rating, such as gallium nitrite-based transistors, can be employed as semiconductor switches, where switching transistors with no avalanche rating must be protected in particular against overvoltages by the unit for limiting and accepting the avalanche energy.

The unit for limiting and accepting the avalanche energy in this case can advantageously be formed as a suppressor diode, where a power Zener diode based on silicon, e.g., can be used as the suppressor diode. Through the suppressor diode, the semiconductor of the switch element is protected against the overvoltage. Power Zener diodes based on silicon are in particular designed for high rated voltages (e.g., up to 440V) and high current pulses or pulse energies. The suppressor diode in this case is formed so that, when the predefined breakthrough voltage is exceeded at the switch element, a current flow is permitted, which can be relayed into the inductance of the input circuit, and so that the switch element withstands the current flowing through the inductance for the duration of the overvoltage. That means that the suppressor diode should be formed so that its breakthrough or avalanche voltage ideally lies below the destruction limit of the switch element or the suppressor diode is dimensioned so that the result of its characteristic curve is a division of the avalanche energy between the switch element and the suppressor diode and thereby neither of the two components is overloaded.

As an alternative, the unit for limiting and accepting the avalanche energy can be formed as a voltage-limiting protection circuit, which comprises at least one capacitance and one diode. The voltage-limiting protection circuit is formed in this case so that it can be switched in via the diode and the avalanche voltage can be emulated via the capacitance. To discharge the capacitance, a resistor and/or a Zener diode can be arranged in parallel with the capacitance.

Ideally, the input circuit has at least buck converter topology. The use of the buck converter, on the one hand, enables an unstabilized and unregulated input voltage to be converted into a stabilized and regulated output voltage smaller in magnitude. Furthermore, a reduction in the harmonics can be achieved by the use of the buck converter.

It is furthermore useful for the active switch unit of the input circuit to be formed as a diode or a Schottky diode. A Schottky diode is a specific diode, which instead of a semiconductor-semiconductor junction possesses a metal-semiconductor junction (known as the Schottky contact) and has a small saturation capacity. This makes the Schottky diode, as a “fast” diode, especially suitable for high-frequency applications and for lowering voltage in inductances (freewheeling diode). Ideally, the Schottky diode is formed as a semiconductor element based on silicon carbide, because these are available up to relatively high blocking voltages and can come very close to ideal diodes, because they have almost no forward and above all reverse recovery behavior and therefore block very rapidly.

In an expedient embodiment of the inventive input circuit the capacitance arranged on the input side is formed as a ceramic or electrolytic capacitor or as a plastic film capacitor.

Furthermore, the switch element is ideally arranged in a positive voltage branch of the input circuit. As an alternative, an arrangement of the switch element in a negative voltage branch of the input circuit is conceivable.

For a use of the inventive input circuit in a multi-stage power supply or for a supply in an AC supply system, a rectifier unit is connected upstream of the input circuit on the input side. Ideally, the rectifier unit is formed such that the input circuit can be linked to an at least two-phase, but above all to a three-phase power supply. The usually unstabilized or rectified output voltage delivered by the rectifier unit in this case forms the input voltage for the inventive input circuit.

For protection against and limiting of overvoltages coming from the supply system, at least one varistor can furthermore be provided on the input side. A varistor is an electronic component that is characterized by a voltage-dependent resistance. The use of at least one varistor enables an overvoltage pulse from build-up of a large pulse power loss to be limited to an overvoltage value able to be predefined or estimated.

Furthermore, the use of the inventive input circuit in a power supply configured as a number of stages enables a converter stage, in particular an electrically isolating converter stage, to be connected downstream. The input voltage of this converter stage is formed by the output voltage of the input circuit, which is made available at the capacitance. Here, the downstream converter stage is protected in an advantageous way against overvoltages by the inventive input circuit.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWING

The invention will be explained below by way of examples, which refer to the enclosed figures, in which:

FIG. 1 schematically shows an exemplary embodiment of the inventive input circuit for a power supply;

FIG. 2 schematically shows a further exemplary embodiment of the inventive input circuit for a power supply;

FIG. 3 shows exemplary plots time graphs of voltages and currents in the inventive input circuit during an input-side overvoltage; and

FIG. 4 shows use of the inventive input circuit in a three-phase power supply in a schematic and exemplary manner.

### DETAILED DESCRIPTION OF THE EXEMPLARY EMBODIMENTS

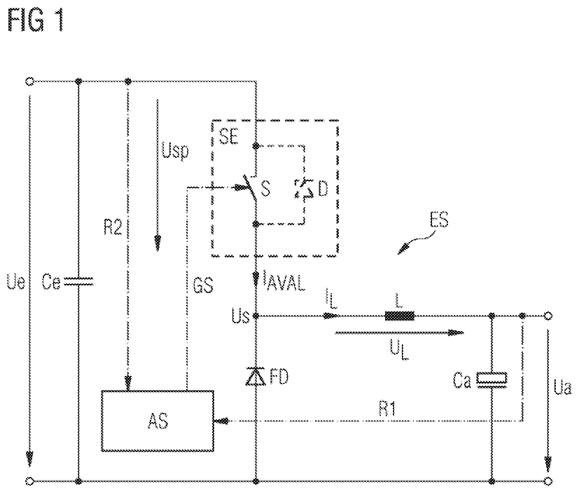

FIG. 1 schematically shows an exemplary embodiment of the inventive input circuit ES for a power supply, which can be linked, for example, to a single or multiphase, especially at least two- or three-phase, power supply system. The input circuit ES has at least a circuit topology of a buck converter. As an alternative, however, the input circuit can also be formed as a combination of buck converter and boost converter. Arranged on an input side of the input circuit ES is an input capacitance Ce, at which a mostly unstabilized or unregulated input voltage Ue is present. The input voltage Ue can, for example, be made available by an input stage of the power supply through which a link to the power supply system is made.

The input capacitance Ce in this case has the function of the input circuit ES for example, which operates with a much higher frequency than the system frequency of the input voltage Ue (e.g., a factor of 1000), to make the high-frequency pulse currents available. A size of the input capacitance C in this case is dimensioned, for example, so that the limit values of the system current harmonics able to be predefined are not exceeded by the overall input circuit ES.

Furthermore, the input circuit ES has a switch element SE arranged on the input side, which can be arranged in a positive voltage branch or in a negative voltage branch, for example. An inductance L is arranged directly or indirectly after the switch element SE. The input circuit ES furthermore has an active switch unit FD that, in terms of switching, for example, can be located arranged in series with the switch element SE or in parallel to the inductance. The active switch unit FD is formed as a diode or as a Schottky diode, which ideally can be switched very rapidly into a blocked state or has a very small blocking delay time. The Schottky diode FD can, for example, be formed as a semiconductor component based on silicon carbide.

Arranged on the output side is an output or intermediate circuit capacitance, at which a usually stabilized or regulated output voltage Ua of the input circuit ES is made available, for example, for a connected consumer or, with a multistage power supply, for a downstream converter stage. In circuit terms, the output capacitance Ca can be arranged in series with the inductance L and thus in parallel to the active switch unit FD. Furthermore, the capacitance Ca can, for example, be formed as a ceramic capacitor, electrolytic capacitor or a plastic film capacitor.

Furthermore, the input circuit ES has an activation unit AS, by which, based on control variables R1, R2, activation pulses GS for the switch element SE are generated. In a normal mode of operation of the input circuit ES, for example, by periodic switching of the switch element SE, the input voltage Ue present on the input side is converted into the stabilized or regulated output voltage, which is usually smaller in amount than the input voltage Ue. To this end, based on a first control variable R1 determined on the output side (e.g., output voltage value determined etc.) by the activation unit AS, activation pulses GS are created. With the activation pulses GS, the switch element SE is alternately put into a conductive state and a blocked state. That is, the switch element SE is alternately switched on and switched off during a switching period. In this case, the inductance L, at least partially during the switching period or when the switch element SE is switched on, has a current I_{L} flowing through it, which charges the capacitance Ca arranged on the output side. The active switch unit FD is blocked when this occurs. In a blocked state of the switch element SE, the current I_{L} commutes through demagnetization of the inductance L into the active switch unit FD, where the energy stored in the inductance L is discharged to the capacitance Ca arranged on the output side (until the inductance L is demagnetized). The switch element SE is then switched into the conductive state again by means of the activation unit AS. This switching process of the switch element SE is repeated periodically during normal operation of the input circuit ES, in order to make regulated output voltage Ua available at the output.

In the event of an overvoltage, interference from the power supply system in the form of overvoltages and/or voltage peaks occur on the input side of the input circuit ES as input voltage Ue, where such overvoltages can already be limited (e.g., to 2000V) by at least one varistor fitted to the input side. On occurrence and recognition of an input-side overvoltage Ue, the switch element SE can be put into a blocked state via an activation pulse GS of the activation unit AS. In this case, a blocking voltage falls at the switch element SE where, when a predefined breakthrough voltage is exceeded at the switch element, which lies above a continuous operating voltage of the switch element SE, through the blocking voltage Usp a current flow I_{AVAL} is permitted via the switch element SE. A point in the circuit between switch element SE, inductance L and active switch unit FD has a voltage potential US. The current flow I_{AVAL} via the switch element SE can be relayed into the inductance L, at which a voltage U_{L} drops, and switches the active switch unit FD off or the active switch unit FD is blocked.

So that the input circuit ES has the necessary dielectric strength for the overvoltage case, the switch element SE and the inductance L are dimensioned such that, on occurrence of the overvoltage, “avalanche energy” arises at the switch element SE, for which the switch element withstands the current I_{L} flowing through the inductance L for the duration of the overvoltage. Usually, such overvoltage pulses or surge voltages are only a few μs long (e.g., with a rise time of 1 to 2 μs and a half-life period of less than 10 μs). The avalanche energy at the switch element SE arises through the current flow I_{AVAL} across the blocked switch element, e.g., in the form of heat, which the switch element must withstand in the event of an overvoltage. The current flow I_{AVAL} and thus the avalanche energy at the switch element SE can be influenced by appropriate dimensioning of the inductance L for a breakthrough voltage able to be predefined at the switch element SE.

To this end, the switch element SE and the inductance L can additionally be dimensioned such that the predefined breakthrough voltage at switch element SE and the output voltage Ua produce at least one sum value at which the current I_{L}, on occurrence of a maximum overvoltage to be expected, remains below a maximum value able to be predefined. That is, if an overvoltage Ue, which is limited, for example, via at least one varistor to 2000V, occurs at the input of the input circuit ES, then a voltage U_{L} drops at the inductance L, which also produces a difference between the input voltage Ue, the predefined breakthrough voltage or the blocking voltage Usp at the switch element SE and the output voltage Ua, which is almost constant (e.g., 400V). By predefining a maximum value of the current I_{L} flowing through the inductance L and with a determinable voltage U_{L} at the inductance L, the inductance L can be dimensioned very easily. The breakthrough voltage Usp at the switch element SE can be predefined, for example, by choice and design of the switch element SE.

With an input-side overvoltage Ue of e.g. 2000V, which is present for 20 μs, for example, and for an output voltage Ua of e.g. 400V and also a predefined breakthrough voltage Usp at the switch element of e.g. 1200V, there remains, for example, as a voltage drop U_{L} at the inductance L e.g. 400V, through which the inductance L is magnetized. In accordance with the relationship U_{L}=L*di/dt, a current I_{L} in the inductance L after reformation to I_{L}=(U/L)*t can be determined. With a known voltage UL and a maximum value able to be predefined for the current I_{L}, a dimensioning for the inductance L can be determined from this.

For recognition of an input-side overvoltage, a comparator unit is provided in the input circuit ES. This can be formed as an autonomous unit or can be integrated into the activation unit AS. A second control variable R2 is employed by the comparator unit, on the basis of which an activation pulse GS is created by the activation unit, through which the switch element SE is put into the blocked state. A measured voltage value or a measured current value can be used as the second control variable R2, for example.

With a measured voltage value as the second control variable R2, the voltage is, for example, determined indirectly or directly on the input side of the input circuit. The input voltage Ue or, for example, a voltage already at the output of a possible upstream stage can be determined, for example, directly at the input of the input circuit. The measured voltage value determined can then be supplied to the comparator unit such that the supplied measured voltage value is compared with a predefined reference value, which can amount to a voltage above an input voltage Ue usual for normal operation and as a maximum to the predefined breakthrough voltage of the switch element SE. If the predefined reference value is exceeded, then the switch element SE is put into the blocked state.

If as an alternative a measured current value is used for recognition of an input-side overvoltage, then to this end a current can be employed that builds up as a consequence of the overvoltage. To this end, the measured current value can be determined with a current sensor, where the current sensor is, for example, arranged in a current path, which comprises the current flow I_{AVAL} across the switch element SE. The measured current value can then be supplied to the comparator unit such that this measured current value is compared with a predefined reference value. If the predefined reference value is exceeded by the measured current value determined and supplied to the comparator unit, then the switch element SE will be put into the blocked state via the activation unit AS.

Furthermore, it is also possible that, for recognition of an input-side overvoltage Ue, a measured voltage value is employed and is compared with a predefined reference value and additionally a current measurement is also performed. Thus, for example, as a function of a voltage form and a rise over time of the overvoltage Ue, the switch element SE can then be switched off either on the basis of the measured voltage value or on the basis of the current measurement.

The switch element SE of the inventive input circuit ES can be formed, for example, as a semiconductor switch or switching transistor S based on silicon carbide (SiC). In particular, the semiconductor switch S based on silicon carbide can be a metal oxide field effect transistor or MOS-FET or a Sic MOS-FET. This Sic MOS-FET ideally has as its component characteristic a predefined minimum acceptance capability for the avalanche energy or an “avalanche rating”, whereby the switching element SE can be dimensioned very easily for the overvoltage case.

As an alternative, the switch element SE (as shown by the dashed line in FIG. 1) can consist of a semiconductor switch S (e.g., MOS-FET based on silicon or gallium nitride) and a unit D arranged in parallel for limiting the acceptance of the avalanche energy in the event of an overvoltage. This unit D can, e.g., be formed as a suppressor diode (as is shown in FIG. 1). A power Zener diode based on silicon can be used as the suppressor diode D.

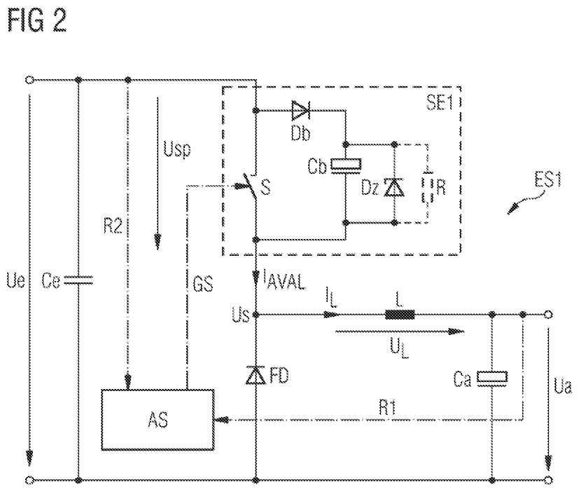

Shown schematically in FIG. 2 is a further exemplary embodiment of the inventive input circuit ES1. This form of embodiment ES1 corresponds to the form of embodiment of the inventive input circuit shown in FIG. 1 except for the configuration of the switch element SE1. In th presently contemplated alternate embodiment, the switch element SE1 consist of a semiconductor switch S (e.g., MOS-FET) and a voltage-limiting protection circuit connected in parallel thereto, through which in the event of an overvoltage, when the semiconductor switch S is blocked, a current flow I_{AVAL} is permitted or the function of a breakthrough voltage is emulated and the semiconductor switch S is protected. Such a protective circuit can, for example, comprise at least one capacitance Cb and also a diode Db, where the capacitance Cb has a pre-charge, for example, through which the predefined breakthrough voltage can be defined. Through the diode Db the capacitance Cb can be switched in, in the event of an overvoltage. Furthermore, a discharge resistor can be arranged in parallel to the capacitance Cb, which can be formed as a suppressor diode Dz or as an ohmic resistance R.

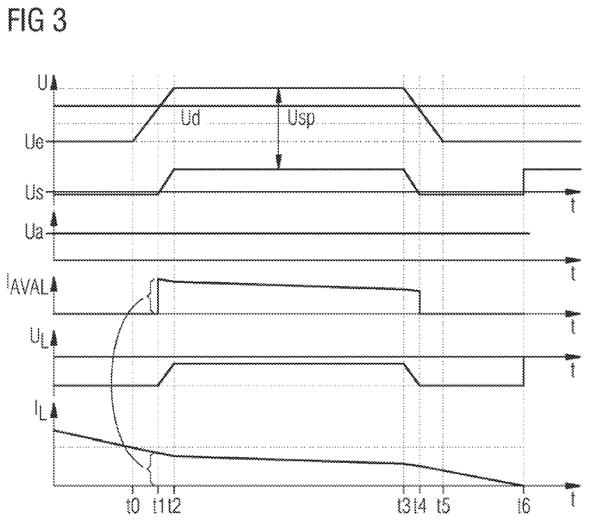

FIG. 3 shows, by way of example and schematically, time graphs of voltages and currents in the inventive input circuit while an input-side overvoltage is occurring. To this end, the time t is plotted on the x axis. Plotted schematically on the y axis are an input voltage Ue of the input circuit ES, a voltage potential Us at the point in the circuit between switch element SE, inductance L and active switch unit FD, an output voltage Ua, a current flow I_{AVAL} via the switch element SE, a voltage UL at the inductance L and also a current I_{L} into the inductance L.

Before a first point in time t0 the input circuit is operating normally. That is, a continuous operating voltage (e.g., 800V) usual for normal operation is present as input voltage at the circuit. The switch element SE is switched into the blocked state, for example, where the entire input voltage Ue plus, e.g., a very small diode flux voltage of the active switch unit FD (e.g., 1V) is present at the switch element SE as the current blocking voltage Usp. The current blocking voltage Usp at the switch element SE in each case can be seen in FIG. 3, for example, from a distance between the two curves of the input voltage and the voltage Us. The inductance L is demagnetized and the current I_{L} in the inductance L falls, where the current I_{L} also flows via the active switch unit FD. The voltage at the potential point Us is below 0 volts by the flux voltage of the active switch unit FD. A constant output voltage Ua is made available to the capacitance arranged on the output side (e.g., 400V).

At the first point in time to, an input-side overvoltage occurs which, for example, can be limited via one or more varistors arranged on the input side to a value able to be predefined (e.g., 2000V). As a consequence of the overvoltage building up on the input side, the input voltage Ue increases. The inductance L is furthermore demagnetized. The blocking voltage Usp at the switch element SE rises, however, with the rising input voltage Ue until, at a second point in time t1, the blocking voltage Usp currently present at the switch element SE reaches or exceeds the predefined breakthrough voltage Ud. As from the second point in time t1, a current flow I_{AVAL} ensues at switch element SE. As from this second point in time t1, the current I_{L}, which flows through the active switch unit FD, commutes at the switch element SE or the current via the active switch unit FD switches off. That is, the entire current I_{L} via the inductance L flows as from the second point in time t1 as I_{AVAL} (as shown in FIG. 3) via the switch element SE. The predefined breakthrough current Ud (e.g., 1700V) is present at the switch element S at the second point in time t1 and a power loss occurs in the switch element SE through this, which is formed by the product of the blocking voltage Usp times the current I_{L} or I_{AVAL}.

At a third point in time t2, the overvoltage value (e.g., 2000V), able to be predefined via varistor limiting, for example, is reached by the input voltage Ue. Furthermore, up to the third point in time t2, the voltage Us as well as the voltage U_{L} at the inductance L have also risen, e.g., to a difference between input voltage Ue and the sum of breakthrough voltage Ud at the switch element SE and output voltage Ua. For an input voltage Ue of, e.g., 2000V, an output voltage Ua of, e.g., 400V and a predefined breakthrough voltage Ud of, e.g., 1700V, a voltage U_{L} of −100V is produced at the inductance L. That is, through the current flow I_{AVAL} via the switch element SE, which is relayed to the inductance L, the voltage U_{L} rises at the inductance L, which thereby receives a lower demagnetization voltage and thereby can only demagnetize itself slowly. Through this, the current I_{L} via the inductance L also only falls slowly or thus also the current flow I_{AVAL} via the switch element SE.

At a fourth point in time t3, such as after 20 to 30 μs, the input-side overvoltage decays and the input voltage Ue falls again, until at a fifth point in time t4 the predefined breakthrough voltage Ud at switch element SE is undershot.

Between the fourth point in time t3 and the fifth point in time t4 (with a constantly increasing breakthrough or blocking voltage at switch element SE), the voltage Us at the point in the circuit between switch element SE, inductance L and active switch element FD also falls in parallel to the input voltage Ue. In a similar way, the voltage UL at the inductance L again falls, i.e., the inductance L again receives as from the fourth point in time t3 a greater demagnetization voltage, whereby the current I_{L} in the inductance can fall more rapidly.

If at the fifth point in time t4, the breakthrough voltage Ud of the switch element SE is reached or undershot, then the entire demagnetization voltage U_{L} is again available to the inductance and the current I_{L} can be discharged undisturbed to the capacitance Ca arranged on the input side. The current I_{L} now falls with a rise as before of the overvoltage, while the current flow I_{AVAL} via the switch element SE is ended, i.e., the switch element SE does not permit any more current to flow as from the fifth point in time t4.

At a sixth point in time t5, the input-side overvoltage has completely decayed. The input voltage Ue has again fallen to the usual continuous operating voltage (e.g., 800V). The inductance L continues to be demagnetized until, at a seventh point in time t6, the entire energy of the inductance L is discharged to the capacitance Ca. The current I_{L} in the inductance L has then fallen to a value of 0. The input circuit ES can then be operated normally again or the switch element SE is switched via an activation pulse GS into a conductive state.

For a dimensioning of the input circuit ES, for example, first the maximum permitted avalanche energy for the switch element SE of for the overall switch element arrangement SE1 (i.e., for the components forming the switch element SE or SE1) is determined from appropriate datasheets. In this case, the maximum working temperature of the switch element SE, SE1 or of all components accepting the avalanche energy to be expected during operation are additionally to be taken into consideration. This can lead to a reduction of the permitted avalanche energy.

The maximum current flow I_{AVAL} is then determined that, in the event of an overvoltage, predefined limit values for the switch element SE, SE1 or the individual components forming the switch element SE, SE1 may not exceed. To this end, a maximum value of the current I_{L} through the inductance at the end of an overvoltage (i.e., at the fifth point in time t4 of FIG. 3, at which the overvoltage has decayed far enough for no more current flow I_{AVAL} to occur through the switch element SE, SE1), is determined. For the determination, it is assumed that the inductance L, at the point in time at which an overvoltage leads to a current flow I_{AVAL} through the switch element SE, SE1 (i.e., at the second point in time t1 of FIG. 3) at which the input voltage/overvoltage Ue exceeds a breakthrough voltage Ud of the switch element SE, SE1) caused by a preceding switching period carries a current I_{L}. Depending on the level of the overvoltage and the limiting voltage of the switch element SE, SE1, in the course of the overvoltage that occurs, the current I_{L} will either fall more slowly in the inductance L or will rise further. In order to cover all eventualities, the current value of the current I_{L} at the second point in time t1 under unfavorable load conditions and also input and output voltage conditions is employed as output condition I0 for the dimensioning of the input circuit ES.

Through the occurrence of an overvoltage and the current flow I_{AVAL} that occurs as a consequence, the voltage as from which the inductance L can demagnetize reduces. Depending on the overvoltage, the breakthrough voltage Ud of the switch element SE, SE1 and the output voltage Ua of the input circuit ES, instead of just a slowing down of the demagnetization, the result can be a magnetization of the inductance L, if, for example, during the overvoltage the voltage Us at the point in the circuit between switch element SE, inductance L and active switch unit FD rises to a higher value than the output voltage Ua. This is taken into consideration in the dimensioning in the Equations 1 and 2 specified below, wherein, as a simplification, a period of time between the points in time t1 and t2 or t3 and t4 is assumed to be extremely short. This assumption, as well as a simplification of the calculation, also represents a conservative approach for the dimensioning. System overvoltage pulses are usually hard to estimate and are rather able to be defined via an energy content. That is, voltage rise times are usually not able to be determined in advance, therefore it is sensible to establish the dimensioning of the input circuit ES for the most unfavorable case, as is described by Equations 1 and 2.

A maximum value of the current I_{L} through the inductance L at the end of an overvoltage, i.e., at the fifth point in time t4, at which the overvoltage has decayed far enough for no more current flow I_{AVAL} to occur through the circuit element SE, SE1, can therefore be determined as follows:

$${I}_{L} ( t 4 ) = I 0 + \frac{U e - U s p - U a}{L} * ( t 4 - t 1 ) \qquad Eq . 1$$

I0—is the value for the current I_{L} through the inductance L at the second point in time t1, at which a current flow I_{AVAL} through the switch element SE, SE1 as a result of the overvoltage Ue begins;
Ue—is the input or overvoltage;
Usp—is the blocking voltage present at the switch element or at the overall switch element with additional circuitry in overvoltage operation, at which a current flow I_{AVAL} flows;
Ua—is the output voltage of the input circuit ES and L is the inductance L of the input circuit ES.

For the determination of the avalanche energy E_{AS} occurring at switch element SE, SE1 between points in time t1 and t4, there can then be a determination in accordance with the following relationship:

E_{AS}=∫ₜ₁^{t4}Usp(t)*I_{VAL}(t) Eq. 2

In this case, the product of the time curve of the blocking voltage Usp at switch element SE, SE1 and the time curve of the current flow I_{AVAL} via the switch element SE, SE1 between the points in time t1 and t4 is integrated. A curve of the current flow in this case, as can be seen in FIG. 3, corresponds to the curve of the current I_{L} through the inductance L.

In conclusion the avalanche energy E_{AS} determined, which occurs at switch element SE, SE1 will also be compared with a predefined maximum permitted avalanche energy from the respective manufacturer of the switch element SE, SE1 or the switch element components. If the determined avalanche energy E_{AS} lies below the maximum permitted avalanche energy, then the switch element SE, SE1 can be used for the input circuit ES.

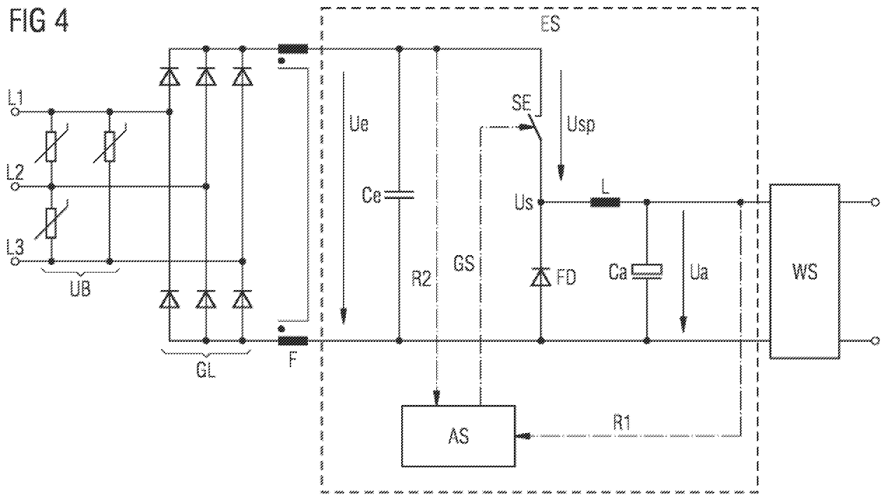

FIG. 4 shows an exemplary use of the inventive input circuit ES in an exemplary power supply configured as a three-phase and multi-phase supply. The exemplary power supply is linked for supply of power to a three-phase power supply system with three phases L1, L2, L3. As an alternative, a single-phase or a two-phase AC voltage can also be provided. Arranged directly at the system connection or before an input stage GL are varistors, through which overvoltages can be limited to an overvoltage value able to be predefined (e.g., 2000V). The components of the power supply arranged downstream of them are therefore protected against high supply system-side overvoltage pulses or voltage peaks of overvoltages. Arranged after the varistors is the input stage GL of the power supply, which is designed as a rectifier unit GL, e.g., with a three-phase power supply, is formed as a 6-pulse rectifier. Through the rectifier unit GL, an unstabilized or unregulated input voltage Ue is created from the AC voltage of the supply system for the stages of the power supply arranged downstream.

The input stage GL can, for example, also be arranged after a filter unit F (e.g., a transformer unit as an EMC filter). Arranged after the input stage GL or the filter unit F is the inventive input circuit ES, which uses the supply voltage rectified by the input stage GL as an unstabilized or unregulated input voltage Ue. This input voltage Ue is converted by the input circuit ES into a stabilized or regulated output voltage Ua of the input circuit. The stabilized or regulated output voltage Ua then forms the input voltage for the downstream converter stage WS, which then delivers a supply voltage for a consumer. The converter stage WS can be formed, for example, as an electrically isolating converter or as a resonant converter, and is protected by the inventive input circuit ES against input-side overvoltages.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-20. (canceled)

21. An input circuit for a power supply comprising:
a switch element arranged on an input side;
an inductance arranged in series with the switch element; and
an active switch unit;
wherein an input voltage is convertible into an output voltage via periodic switching of the switch element between a conductive state and a blocked state;
wherein a current flowing at least partially flow through the inductance during a switching period of the switch element, said current charging a capacitance arranged on an output side at which the output voltage is able to be made available;
wherein the active switch unit absorbs the current in a blocked state of the switch element;
wherein a current flow via the switch element is permitted in the blocked state of the switch element when a predefined breakthrough voltage at the switch element is exceeded;
wherein the switch element is switchable into the blocked state upon recognition of an overvoltage on the input side of the input circuit;
wherein the current flow via the switch element is relayable to the inductance and switches off the active switch unit; and
wherein the switch element and the inductance are dimensioned such that, upon occurrence of the overvoltage, an avalanche energy arises at the switch element, at which the switch element withstands a current flowing through the inductance for a duration of the overvoltage.

22. The input circuit as claimed in claim 21, wherein the switch element and the inductance are further dimensioned such that the predefined breakthrough voltage at the switch element and the output voltage produce at least one sum value at which the current through the inductance, upon occurrence of a maximum overvoltage to be expected, remains below a maximum predefineable value.

23. The input circuit as claimed in claim 21, further comprising:
an activation unit for activating the switch element such that the switch element is supplied with activation pulses, which alternately place the switch element into the conductive state and the blocked state.

24. The input circuit as claimed in claim 21, further comprising:
a comparator unit for recognizing the input-side overvoltage;
wherein the comparator unit is suppliable with indirectly or directly determinable voltage value on the input side of the input circuit such that the switch element, if a predefined reference value is exceeded by the determined and supplied measured voltage value (R2), is placed into the blocked state.

25. The input circuit as claimed in claim 22, further comprising:
a comparator unit for recognizing the input-side overvoltage;
wherein the comparator unit is suppliable with indirectly or directly determinable voltage value on the input side of the input circuit such that the switch element, if a predefined reference value is exceeded by the determined and supplied measured voltage value, is placed into the blocked state.

26. The input circuit as claimed in claim 23, further comprising:
a comparator unit for recognizing the input-side overvoltage;
wherein the comparator unit is suppliable with indirectly or directly determinable voltage value on the input side of the input circuit such that the switch element, if a predefined reference value is exceeded by the determined and supplied measured voltage value, is placed into the blocked state.

27. The input circuit as claimed in claim 21, further comprising:
a comparator unit for recognizing the input-side overvoltage based on a current building up as a consequence;
wherein the comparator unit is suppliable with a measured current value determined by via a current sensor such that the switch element, if the predefined reference value is exceeded by the determined and supplied measured current value, is placed into the blocked state.

28. The input circuit as claimed in claim 22, further comprising:
a comparator unit for recognizing the input-side overvoltage based on a current building up as a consequence;
wherein the comparator unit is suppliable with a measured current value determined by via a current sensor such that the switch element, if the predefined reference value is exceeded by the determined and supplied measured current value, is placed into the blocked state.

29. The input circuit as claimed in claim 23, further comprising:
a comparator unit for recognizing the input-side overvoltage based on a current building up as a consequence;
wherein the comparator unit is suppliable with a measured current value determined by via a current sensor such that the switch element, if the predefined reference value is exceeded by the determined and supplied measured current value, is placed into the blocked state.

30. The input circuit as claimed in claim 21, wherein the switch element comprises a semiconductor switch.

31. The input circuit as claimed in claim 21, wherein the semiconductor switch comprises a metal oxide field effect transistor based on silicon carbide.

32. The input circuit as claimed in claim 31, wherein the semiconductor switch based on silicon carbide has a predefined minimum acceptance capability for the avalanche energy as a characteristic component value.

33. The input circuit as claimed in claim 21, wherein the switch element comprises a semiconductor switch and a unit for limiting and accepting the avalanche energy which is arranged in parallel with the semiconductor switch.

34. The input circuit as claimed in claim 21, wherein the semiconductor switch comprises a switching transistor.

35. The input circuit as claimed in claim 33, wherein the unit for limiting and accepting the avalanche energy comprises a suppressor diode, especially as a power Zener diode based on silicon.

36. The input circuit as claimed in claim 33, wherein the suppressor diode comprises a power Zener diode based on silicon.

37. The input circuit as claimed in claim 33, wherein the unit for limiting and accepting the avalanche energy comprises voltage-limiting protective circuitry which comprises at least a capacitance and a diode.

38. The input circuit as claimed in claim 21, wherein the input circuit include at least buck converter topology.

39. The input circuit as claimed in claim 21, wherein the active switch unit comprises a diode.

40. The input circuit as claimed in claim 21, wherein the active switch unit comprises a Schottky diode.

41. The input circuit as claimed in claim 40, wherein the Schottky diode is formed from silicon carbide.

42. The input circuit as claimed in claim 21, wherein the capacitance arranged on the output side comprises one of (i) a ceramic capacitor, (ii) an electrolytic capacitor and (iii) a plastic film capacitor.

43. The input circuit as claimed in claim 21, wherein the switch element is arranged in a positive voltage branch of the input circuit.

44. The input circuit as claimed in claim 21, wherein the switch element is arranged in a negative voltage branch of the input circuit.

45. The input circuit as claimed in claim 21, further comprising:
a rectifier unit arranged on the input side for linking the input circuit to an at least two-phase power supply system.

46. The input circuit as claimed in claim 21, further comprising:
at least one varistor arranged on the input side for limiting overvoltage that occurs.

47. The input circuit as claimed in claim 21, wherein the input circuit includes a converter stage which is arranged downstream of said input circuit on the output side, an input voltage of the converter stage being formed by the output voltage of the input circuit made available at the capacitance.

48. The input circuit as claimed in claim 21, wherein the converter stage comprises an electrically isolating converter stage.
